(19) United States
(12) Patent Application Publication
(10) Pub. No.: US 2006/0101168 A1
(43) Pub. Date: May 11, 2006

(54) Apparatus and method for allocating data bursts in a broadband wireless communication system

(75) Inventors: Kwan-Hee Roh, Suwon-si (KR); Soon-Young Yoon, Seoul (KR); Jae-Hee Cho, Seoul (KR); In-Seok Hwang, Seoul (KR); Sang-Hoon Sung, Suwon-si (KR); Hoon Huh, Sungnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS, CO., LTD., Suwon-si (KR)

(21) Appl. No.: 11/254,571

(22) Filed: Oct. 20, 2005

(30) Foreign Application Priority Data
Oct. 21, 2004 (KR) 2004-0084261

(51) Int. Cl. G06F 13/28

(52) U.S. Cl. 710/33

(57) ABSTRACT

An apparatus and method for adjusting a data region to which data bursts are allocated in a broadband wireless communication system are provided. A cell load is calculated using information about data bursts to be transmitted and then compared with a predetermined threshold. A data region is adjusted based on the cell load such that a subchannel occupation rate is uniform over an entire data burst transmission time period, if the cell load is less than the threshold.

### PRIORITY

This application claims priority under 35 U.S.C. § 119 to an application entitled “Apparatus And Method For Allocating Data Bursts In A Broadband Wireless Communication System” filed in the Korean Intellectual Property Office on Oct. 21, 2004 and assigned Ser. No. 2004-84261, the contents of which are incorporated herein by reference.

### BACKGROUND OF THE INVENTION

1. Field of the Invention

The present invention relates generally to an apparatus and method for allocating data bursts in a broadband wireless communication system, and in particular, to an apparatus and method for adjusting a data burst allocation region according to a cell load during a Hybrid Automatic Repeat reQuest (HARQ) operation in an Orthogonal Frequency Division Multiple Access (OFDMA) communication system.

2. Description of the Related Art

Studies have been conducted to provide users with services with different Quality of Service (QoS) requirements at about 100 Mbps in a 4^{th} generation communication system. Existing 3^{rd} generation communication systems support a data rate of about 384 Kbps in a relatively bad outdoor channel environment and a data rate of up to 2 Mbps in a relatively good indoor channel environment.

A Wireless Local Area Network (WLAN) system and a Wireless Metropolitan Area Network (WMAN) usually support data rates of 2 Mbps to 50 Mbps. Further, because its wide coverage and high data rates, the WMAN system is suitable for high-speed communication service. However, the WMAN system is not designed to handle the mobility of Subscriber Stations (SSs). In this context, ensuring mobility and QoS for the WLAN and WMAN systems that provide relatively high data rates is an important feature in the 4^{th} generation communication system, which has yet to be determined.

The Institute Electric and Electronic Engineers (IEEE) 802.16 is a global standard applying Orthogonal Frequency Division Multiplexing (OFDM) and OFDMA to the WMAN physical channel. The IEEE 802.16 OFDM-OFDMA communication system realizes high-speed data transmission by transmitting a physical channel signal on multiple subcarriers.

Using multiple subcarriers, the OFDMA communication system can allocate radio resources on a two-dimensional time-frequency plane and as a result, actively transmit data bursts of various sizes.

In recent years, studies have been further extended to investigate a system with a frequency reuse factor of 1 to increase spectral efficiency in cellular networks. In this system, adjacent cells or sectors use the same resources simultaneously. Consequently, co-channel interference is a significant issue to tackle. Without proper control of the interference between adjacent cells or sectors, serious performance degradation may result.

The smallest unit of data burst allocation is a slot in the OFDMA communication system. The slot is defined by symbols on the time axis and subchannels on the frequency axis. The definition of the slot varies depending on subcarrier allocation to symbols. For example, in downlink Partial Usage of SubCarrier (DL PUSC), a slot is defined as one subchannel in frequency and two symbols in time. A set of slots for a predetermined period of time is called a data region.

FIG. 1 illustrates an example of a data region for the DL PUSC proposed by IEEE 802.16. As illustrated in FIG. 1, one slot is composed of one subchannel and two successive symbols, and one data region is a set of successive slots on a two-dimensional symbol-subchannel plane. A data burst is mapped to a data region according to a Connection Identifier (CID) and allocated the absolute position of a frame by a symbol offset value and a subchannel offset value set in a DL/UL MAP message.

However, when HARQ is implemented in the OFDMA system, a data burst is allocated one-dimensionally. When using a band Adaptive Modulation and Coding (AMC) subchannel, a data burst is mapped to a data region by directly allocating a band number by a MAP message, or using a band bitmap.

When using a diversity subchannel, a coding rate, a modulation order, and the number of allocated subchannels for a corresponding data burst are notified by N_{EP} and N_{SCH} fields of a MAP message. Data bursts are sequentially allocated to a data region, starting from the first subchannel area of the first symbol in the data region. That is, during an HARQ operation, data bursts sequentially fill a data region one-dimensionally rather than they are allocated two-dimensionally by means of symbol offsets and subchannel offsets. Sequential allocation means sequential column-by-column filling on a two-dimensional plane as illustrated in FIG. 1. Accordingly, transmission data is allocated to all subchannels in one OFDM interval and then to the next OFDM interval.

The one-dimensional data allocation faces the problem of data bursts concentrated on the leading part of a frame irrespective of the load state of each cell. A cell load is defined as the ratio of actually allocated resources to total available resources. Inter-channel interface linearly increases with cell load. Particularly, resource allocation centered on part of a frame leads to concentration of inter-cell interference (or subcarrier collision probability) on a specific period. Therefore, a need exists for a method of maintaining inter-cell interference at a predetermined level over an entire frame when a cell load is small.

### SUMMARY OF THE INVENTION

Therefore, the present invention has been designed to substantially solve at least the above problems and/or disadvantages and to provide at least the advantages below. Accordingly, an object of the present invention is to provide an apparatus and method for adjusting a data burst allocation region according to the load state of a cell in an OFDMA communication system.

Another object of the present invention is to provide an apparatus and method for adjusting a data burst allocation region according to a load state of a cell during an HARQ operation in an OFDMA communication system.

A further object of the present invention is to provide an apparatus and method for maintaining inter-cell interference or inter-sector interference at a predetermined level over an entire frame in an OFDMA communication system.

Still another object of the present invention is to provide an apparatus and method for maintaining a subcarrier collision probability between adjacent cells or sectors at a predetermined level over an entire frame in an OFDMA communication system.

The above objects are achieved by providing an apparatus and method for adjusting a data region to which data bursts are allocated in a broadband wireless communication system.

According to one aspect of the present invention, in a transmission method in a broadband wireless communication system, a cell load is calculated using information about data bursts to be transmitted and compared with a predetermined threshold. A data region is adjusted based on the cell load, such that a subchannel occupation rate is uniform over a time period, if the cell load is less than the threshold.

According to another aspect of the present invention, in a reception method in a broadband wireless communication system, it is determined whether data region adjustment information exists in a received resource allocation message. In the presence of the data region adjustment information, data bursts in an adjusted data region, indicated by the data region adjustment information, are received. In the absence of the data region adjustment information, data bursts in a data region allocated for a predetermined symbol permutation mode are received.

According to a further aspect of the present invention, in a transmitter in a broadband wireless communication system, a scheduler adjusts a data region so that a subchannel occupation rate is uniform over a time period, if a cell load is less than the threshold. A mapper maps transmission data to subchannels of the adjusted data region. An IFFT processor generates an IFFT signal by IFFT-processing the mapped data.

According to still another aspect of the present invention, in a receiver in a broadband wireless communication system, upon receipt of a resource allocation message including information about a data region adjusted according to a cell load, a controller generates a control signal to receive data in the adjusted data region. An FFT processor FFT-processes a received signal and outputs subcarrier values. A demapper extracts subcarrier values with actual data among the subcarrier values received from the FFT processor.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates an example of a data region for the DL PUSC proposed by IEEE 802.16;

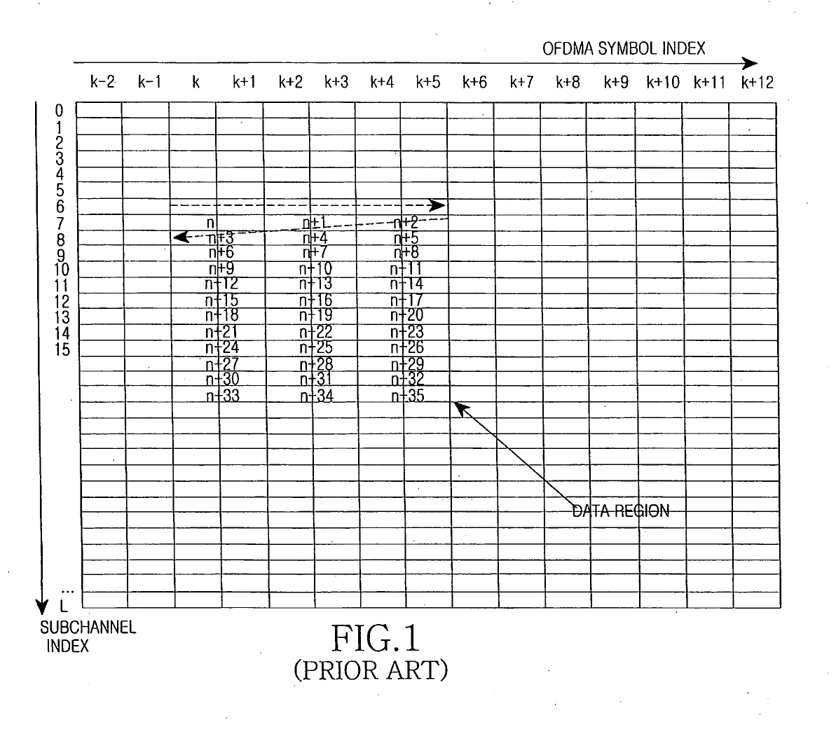

FIG. 2 is a flowchart illustrating an operation for adjusting a data burst allocation region according to a cell load state in an OFDMA communication system using HARQ according to an embodiment of the present invention;

FIG. 3 is a block diagram of a transmitter and a receiver in the OFDMA communication system according to an embodiment of the present invention;

FIG. 4 is a diagram illustrating a signal flow for exchanging messages between a Base Station (BS) and an SS in the OFDMA communication system using HARQ according to an embodiment of the present invention;

FIG. 5 illustrates an HARQ MAP message according to an embodiment of the present invention; and

FIG. 6 illustrates data burst mapping using an HARQ MAP message according to the present invention.

### DETAILED DESCRIPTION OF THE PREFERRED EMBODIMENTS

Preferred embodiments of the present invention will be described in detail herein below with reference to the accompanying drawings. In the following description, well-known functions or constructions are not described in detail since they would obscure the invention in unnecessary detail.

The present invention provides a method of adjusting a data burst allocation region according to a cell load state in an OFDMA communication system. When transmission data or data bursts are allocated one-dimensionally on a two-dimensional symbol (time)-subchannel (frequency) plane, the data is distributed uniformly on the time axis in order to minimize inter-cell interference or inter-sector interference caused by concentration of data in a predetermined period of time. The present invention is applicable to any system that allocates data bursts one-dimensionally on the two-dimensional symbol-subchannel plane. It is to be appreciated herein that the following description is made in the context of an OFDMA communication system using HARQ.

Adjustment of a data burst allocation region requires a newly defined message. According to the present invention, a novel “Load_IE MAP message” is defined to actively adjust a data burst allocation region according to a cell load state. Data bursts are sequentially allocated in a data region indicated by the Load_IE MAP message.

Table 1 and Table 2 below show the structures of DL and UL (uplink) Load_IE MAP messages, respectively, according to the present invention.

TABLE 1

| | |
|---|---|
| Syntax | Size |

Load_IE ( ){

| | |
|---|---|
| DL-MAP Type=7 | 3 bits |
| DL-MAP subtype | |
| Length | 4 bits |
| DL Symbol offset | 8 bits |
| DL Subchannel offset | 6 bits |

}

As noted from Table 1, the DL Load_IE MAP message includes DL resource allocation information. A code identifying the message is written in DL-MAP Type, the position of the first symbol of a data region adjusted according a cell load state is indicated by DL Symbol offset, and the subchannel offset of the adjusted data region is written in DL Subchannel offset.

TABLE 2

| | |
|---|---|
| Syntax | Size |

Load_IE ( ){

| | |
|---|---|
| UL-MAP Type=7 | 3 bits |
| UL-MAP subtype | |
| Length | 4 bits |
| UL Symbol offset | 8 bits |
| UL Subchannel offset | 6 bits |

}

Referring to Table 2, the UL Load_IE MAP message includes UL resource allocation information. A code identifying the message is written in UL-MAP Type, the position of the first symbol of a data region adjusted according a cell load state is indicated by UL Symbol offset, and the subchannel offset of the adjusted data region is written in UL Subchannel offset.

The DL and UL Load_IE MAP messages are the same in configuration and data region adjustment is performed in the same manner on both the DL and the UL, as known from these messages. Hereinbelow, the following description focuses on DL data region adjustment.

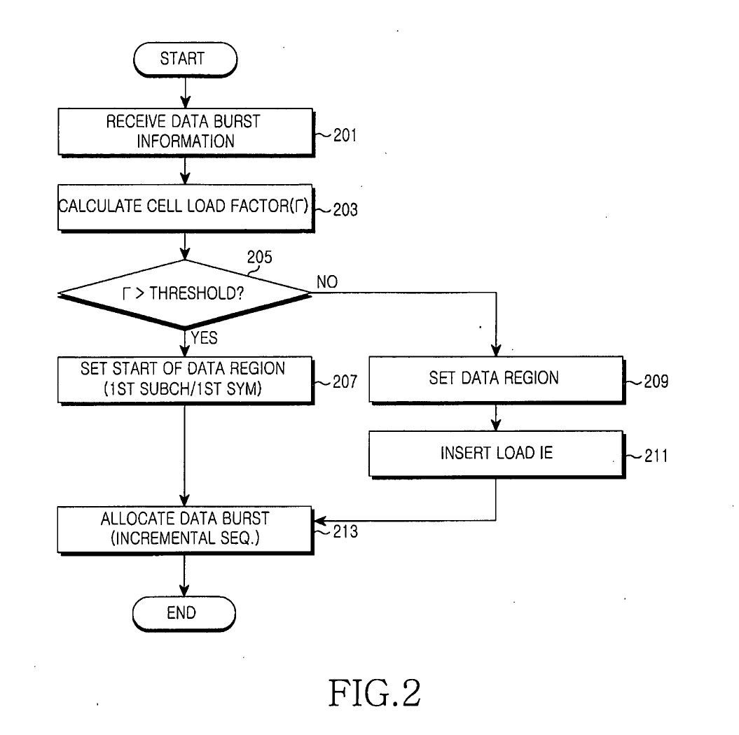

FIG. 2 is a flowchart illustrating an operation for adjusting a data burst allocation region according to a cell load state in an OFDMA communication system using HARQ according to an embodiment of the present invention. Because a BS scheduler typically generates a DL/UL MAP message, it is assumed that the BS scheduler performs the following process.

Referring to FIG. 2, the scheduler receives information about data bursts to be transmitted from an upper layer in step 201 and calculates a current cell load state based on the total size of the data bursts in step 203. The scheduler calculates a cell load factor Γ representing a channel occupation ratio of payload, not including the overhead of control information, and a MAP message in an entire frame.

In step 205, the scheduler compares the cell load factor with a predetermined threshold. If the cell load factor is greater than the threshold, the scheduler sets a data region in a conventional manner in step 207. That is, the scheduler sets the first subchannel and symbol of the data region set for FUSC (Full Usage of SubCarrier) in an HARQ MAP message.

In step 213, the scheduler sequentially allocates the data bursts in the data region, starting from the first subchannel and symbol. When the cell load state is at or above a predetermined level, there is not much gain in adjusting a data burst allocation region in a frame by means of Load IE. Therefore, the data bursts are allocated sequentially in the data region set for FUSC. For a cell load of 100%, there is no gain, only with an increased overhead from an added MAP message (Load IE) in the present invention.

However, in step 205, if the cell load factor is equal to or less than the threshold, the scheduler adjusts the data region based on the cell load factor by determining the first symbol and the number of subchannels equivalent to the length of a frequency axis for the data region in step 209. In step 211, the scheduler writes a Load IE using resource allocation information about the adjusted data region and inserts the Load IE in an HARQ MAP message.

In step 213, the scheduler allocates the data bursts in the data region sequentially starting from the first subchannel and symbol.

As described above, despite the one-dimensional data allocation structure as in HARQ, the number of subchannels is limited by a cell load state. As a result, a subchannel occupation rate is kept constant over the entire time period.

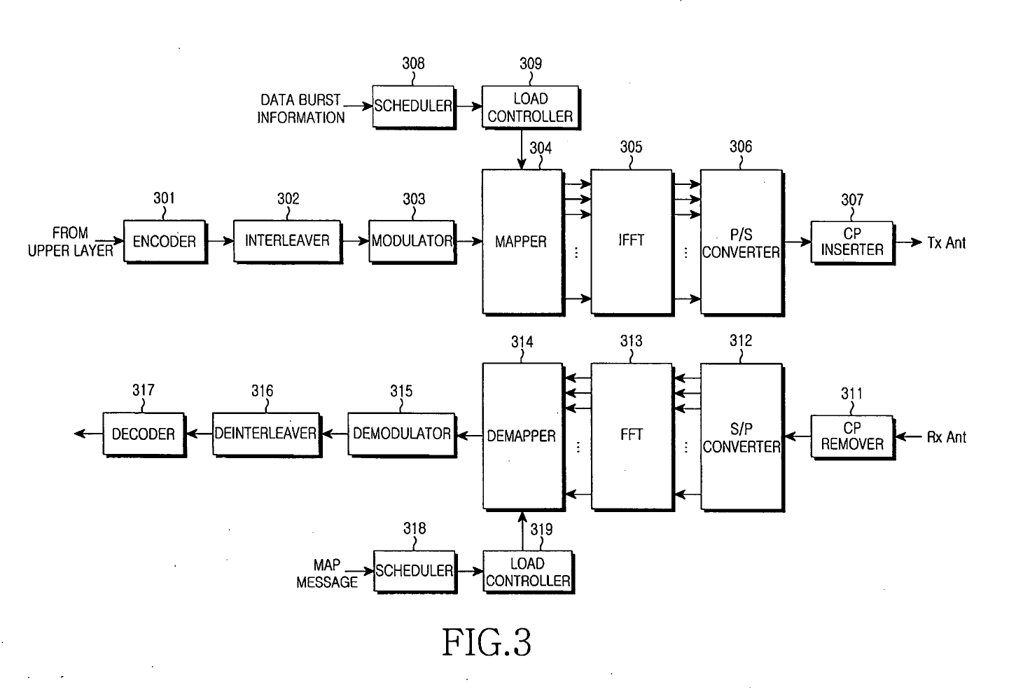

FIG. 3 is a block diagram of a transmitter and a receiver in the OFDMA communication system according to an embodiment of the present invention. Referring to FIG. 3, the transmitter includes an encoder 301, an interleaver 302, a modulator 303, a mapper 304, an inverse fast Fourier transform (IFFT) processor 305, a parallel-to-serial (P/S) converter 306, a Cyclic Prefix (CP) inserter 307, a scheduler 308, and a load controller 309. The receiver includes a CP remover 311, a serial-to-parallel (S/P) converter 312, a fast Fourier transform (FFT) processor 313, a demapper 314, a demodulator 315, a deinterleaver 316, a decoder 317, a scheduler 318, and a load controller 319.

For data transmission from the transmitter, the encoder 301 channel-encodes transmission data, i.e. burst data, received from an upper layer at a predetermined coding rate. For k information bits and a coding rate of R, k/R code symbols are output. For example, the encoder 301 can be a convolutional encoder, a turbo encoder, or a Low Density Parity Check (LDPC) encoder.

The interleaver 302 interleaves the code symbols in a predetermined interleaving method to make them to be robust against burst errors. The modulator 303 maps the interleaved symbols to signal points in a predetermined modulation scheme and outputs complex signals. For example, the modulation scheme can be Binary Phase Shift Keying (BPSK), Quadrature Phase Shift Keying (QPSK), 8ary Quadrature Amplitude Modulation (8QAM), or 16QAM. One bit (s=1) is mapped to one signal point (complex signal) in BPSK, two bits (s=2) to one complex signal in QPSK, three bits (s=3) to one complex signal in 8QAM, and four bits (s=4) to one complex signal in 16QAM.

The scheduler 308 calculates a current cell load factor Γ using the size information of the data bursts and compares the cell load factor with a predetermined threshold. If the cell load factor is less than the threshold, the scheduler 308 forms a Load IE and inserts the Load IE in an HARQ MAP message. Simultaneously, the scheduler 308 provides the Load IE information (symbol offset and subchannel offset) to the load controller 309. The HARQ MAP message is transmitted to SSs being served by the BS.

The load controller 309 controls the mapper 304 such that the transmission data can be allocated in a data region according to the Load IE information. The data region is a resource defined by the number of subchannels and an entire time period (the entire time period of FUSC).

The mapper 304 maps the complex signals received from the modulator 303 to corresponding subchannels or subcarriers under the control of the load controller 309. Mapping to subchannels refers to providing the complex signals to corresponding IFFT inputs, i.e. subcarrier positions. If the cell load factor is equal to or less than the threshold, the complex signals are mapped only to a predetermined number of subchannels or subcarriers under the control of the load controller 308.

The IFFT processor 305 IFFT-processes the mapped signals and outputs time-domain sample data. The P/S converter 306 converts the parallel IFFT data to serial data. The CP inserter 307 inserts a copy of a predetermined last part of the serial sample data, thereby generating an OFDM symbol. Although not shown, the baseband OFDM symbol is upconverted to a Radio Frequency (RF) signal transmittable over the air and transmitted over the air through an antenna.

For data reception at the receiver, a received RF signal is downconverted to a baseband signal and the analog baseband signal is converted to time-domain sample data. The CP remover 311 removes a CP from the sample data. The S/P converter 312 converts the serial CP-removed data to parallel data for input to the FFT processor 313.

The FFT processor 313 FFT-processes the parallel data and outputs frequency-domain data. The scheduler 318 schedules based on an HARQ MAP message received from the transmitter (the BS). The scheduler 318 determines a DL data region according to the Load IE information of the HARQ MAP message, determines the start and end of data bursts to be received based on the allocation information N_{EP} and N_{SCH} of data bursts transmitted by the BS, and notifies the load controller 319 of the start and end of the data bursts.

The load controller 319 controls the demapper 314 based on the information received from the scheduler 318. The demapper 314 extracts valid subcarrier values with the data that the receiver is supposed to receive among the subcarrier values received from the FFT processor 313.

The demodulator 315 demodulates the subcarrier values (complex signals) received from the demapper 314 in a given demodulation scheme. The deinterleaver 316 deinterleaves the demodulated symbols in a given method. The decoder 317 channel-encodes the deinterleaved symbols, thereby recovering the information bit stream transmitted by the transmitter.

As described above, the transmitter allocates data bursts in a predetermined data region according to a cell load state that the transmitter itself has evaluated. If the cell load is smaller than a predetermined threshold, the transmitter allocates the data bursts sequentially in the data ration defined by a predetermined number of subchannels and the entire time period. That is, the mapper 304 maps the data to only some subchannels indicated by a Load IE under the control of the load controller 309. Information about the data region adjusted according to the cell load is transmitted to the SS (the receiver) by the Load IE in an HARQ MAP message. The SS receives the data bursts based on the HARQ MAP information.

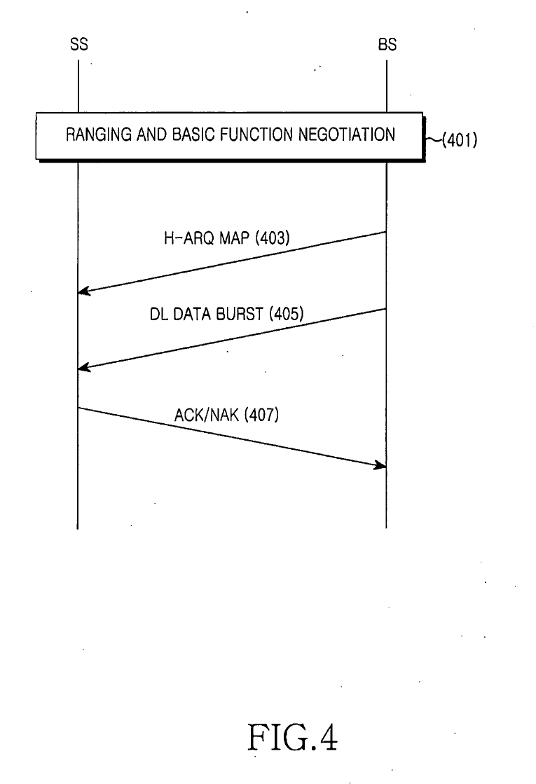

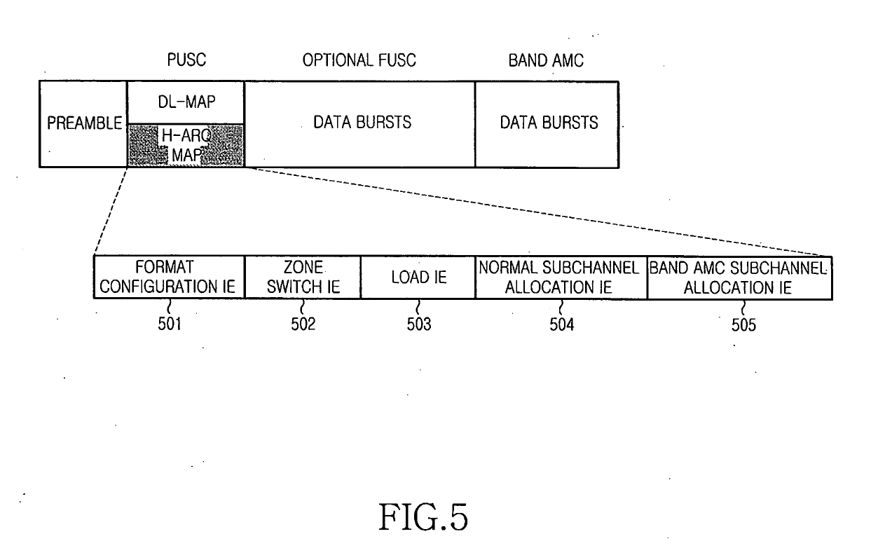

FIG. 4 is a diagram illustrating a signal flow for exchanging messages between a BS and an SS in an OFDMA communication system using HARQ according to an embodiment of the present invention. Referring to FIG. 4, the SS and the BS agree on HARQ by signaling negotiations at an initial connection in step 401. For an HARQ operation, the BS generates an HARQ MAP message including data region allocation information and transmits the HARQ MAP message to the SS in step 403. The HARQ MAP message has a configuration as will be described below and is illustrated in FIG. 5. The HARQ MAP message contains information about a data region adjusted according to a cell load, namely a Load IE. The Information Elements (IEs) of the HARQ MAP message will be described later.

After transmitting the HARQ MAP message, the BS allocates DL data bursts sequentially in the adjusted data region based on the HARQ MAP information and transmits the DL data bursts to the SS in step 405. The SS receives the data bursts based on the resource allocation information set in the HARQ MAP message, checks errors in the data bursts, and feeds back an error check result (ACK or NAK) to the BS in step 407.

FIG. 5 illustrates an HARQ MAP message according to an embodiment of the present invention. Referring to FIG. 5, the HARQ MAP message includes a Format Configuration IE 501, a Zone Switch IE 502, a Load IE 503, a Normal Subchannel Allocation IE 504, and a band AMC Subchannel Allocation IE 505. More specifically, the Format Configuration IE 501 provides frame configuration information. Resources (a data region) for the FUSC and resources (a data region) for the band AMC are known from the Format Configuration IE 501. The Zone Switch IE 502 indicates the permutation mode of a symbol, that is, a PUSC (Partial Usage of SubCarrier) mode or a Full Usage of SubCarrier (FUSC) mode.

The Load IE 503 provides information about a data region adjusted according to a cell load state. As described with reference to Table 1 and Table 2, the Load IE 503 contains symbol offset information indicating a start of the adjusted data region and subchannel offset information indicating a number of subchannels used on a frequency axis. Depending on the cell load state, the Load IE 503 is or is not inserted in the HARQ MAP message. If the cell load state is equal to or less than a predetermined threshold, the BS inserts the Load IE 503 in the HARQ MAP message.

The Normal Subchannel Allocation IE 504 includes information about the allocation of each data burst in the FUSC mode, i.e., information N_{EP} indicating the coding rate and modulation order of a subpacket or data burst and information N_{SCH} about the number of allocated subchannels. The SS determines the size of each data burst from N_{EP} and thus the position of the data burst to be received using its size. For example, assuming that ten subchannels are allocated to user A, five subchannels to user B, and eight subchannels to user C, user C receives his data bursts 15 subchannels after the data region indicated by the Load IE 503.

The Band AMC Subchannel Allocation IE 505 indicates the number of a band to which each data burst is allocated. If the receiver receives the Normal Subchannel Allocation IE 504 without receiving the Load IE 503, it receives its data bursts at a position counted from the start of the data region for the FUSC.

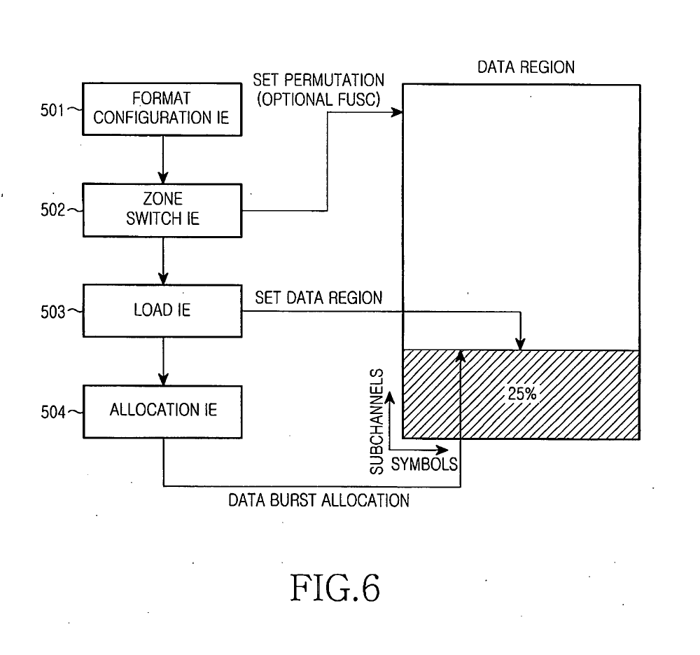

FIG. 6 illustrates data burst mapping using an HARQ MAP message according to the present invention. Referring to FIG. 6, a data region is first allocated for the FUSC according to the Format Configuration IE 501 in the HARQ MAP message. Then, the symbol permutation mode of a frame is changed to optional FUSC by the Zone Switch IE 502. If a current cell load state that the system has evaluated is equal to or less than a predetermined threshold, a data region is set according to the cell load state by the Load IE 503 and data bursts are allocated in the data region sequentially starting from the start of the data region. For example, if the current cell load is 25%, a 25% upper or lower area of the data region for the FUSC is set as a data region that will carry actual data bursts by the Load IE 503.

After the data region adjustment, data bursts received from an upper layer are sequentially allocated in the adjusted data region by the Normal Subchannel Allocation IE 504.

Conventionally, data bursts are allocated such that the subchannel load is 100% for a fourth of a symbol period and 0% for the remaining three fourths of the symbol period. However, the data region adjustment according to a cell load state by the Load IE 503 leads to a uniform subchannel load of 25% over the whole symbol period. Therefore, the concentration of inter-cell or inter-sector interference in a certain time period is avoided.

In accordance with the present invention as described above, for one-dimensional resource allocation in an OFDMA communication system, a data region is adjusted according to a cell load state, thereby avoiding concentration of resources in a specific time period. For a small cell load, allocated resources are distributed uniformly along the time axis in order to prevent inter-cell interference and performance degradation caused by resource concentration.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A transmission method in a broadband wireless communication system, comprising the steps of:
calculating a cell load using information about data bursts to be transmitted;
comparing the cell load with a threshold; and
adjusting a data region based on the cell load such that a subchannel occupation rate is uniform over an entire data burst transmission time period, if the cell load is less than the threshold.

2. The transmission method of claim 1, further comprising the step of sequentially allocating the data bursts in the adjusted data region and transmitting the data bursts.

3. The transmission method of claim 1, further comprising the step of forming a resource allocation message including information about the adjusted data region and transmitting the resource allocation message to a receiver.

4. The transmission method of claim 3, wherein the information about the adjusted data region includes a symbol offset value indicating a start of the adjusted data region and a subchannel offset value indicating subchannels occupied by the adjusted data region.

5. The transmission method of claim 3, wherein the resource allocation message is a hybrid automatic repeat request (HARQ) MAP message.

6. The transmission method of claim 1, further comprising the step of sequentially allocating the data bursts in a data region set for full usage of subcarrier (FUSC), if the cell load is greater than the threshold.

7. A reception method in a broadband wireless communication system, comprising the steps of:
determining if data region adjustment information exists in a received resource allocation message;
receiving data bursts in an adjusted data region indicated by the data region adjustment information, if the data region adjustment information exists; and
receiving data bursts in a data region allocated for a predetermined symbol permutation mode, if the data region adjustment information does not exist.

8. The reception method of claim 7, wherein the resource allocation message is a hybrid automatic repeat request (HARQ) MAP message.

9. The reception method of claim 7, wherein the predetermined symbol permutation mode is full usage of subcarrier (FUSC).

10. The reception method of claim 7, wherein the data region adjustment information includes a symbol offset value indicating a start of the adjusted data region and a subchannel offset value indicating subchannels occupied by the adjusted data region.

11. A transmission method in a broadband wireless communication system, comprising the steps of:
calculating a cell load using information about data bursts to be transmitted in a hybrid automatic repeat request (HARQ) mode;
setting a data region according to the cell load;
transmitting a resource allocation message including information about the data region;
sequentially allocating the data bursts in the data region; and
transmitting the data bursts.

12. The transmission method of claim 11, wherein the step of transmitting the resource allocating message comprises the steps of:
comparing the cell load with a predetermined threshold;
adjusting the data region based on the cell load such that a subchannel occupation rate is uniform over a data burst transmission time period, if the cell load is less than the threshold;
generating the resource allocation message including the information about the data region; and
transmitting the resource allocation message.

13. The transmission method of claim 11, wherein the information about the adjusted data region includes a symbol offset value indicating a start of the adjusted data region and a subchannel offset value indicating subchannels occupied by the adjusted data region.

14. A transmitter in a broadband wireless communication system, comprising:
a scheduler for adjusting a data region such that a subchannel occupation rate is uniform over an entire data burst transmission time period, if a cell load is less than the threshold;
a mapper for mapping transmission data to subchannels of the adjusted data region; and
an inverse fast Fourier transform (IFFT) processor for generating an IFFT signal by IFFT-processing the mapped data.

15. The transmitter of claim 14, wherein the scheduler generates a resource allocation message including information about the adjusted data region and the resource allocation message is transmitted to a receiver.

16. The transmitter of claim 15, wherein the information about the adjusted data region comprises:
a symbol offset value indicating a start of the adjusted data region; and
a subchannel offset value indicating subchannels occupied by the adjusted data region.

17. The transmitter of claim 15, wherein the resource allocation message is a hybrid automatic repeat request (HARQ) MAP message.

18. The transmitter of claim 14, further comprising a radio frequency (RF) processor for upconverting the IFFT signal to an RF signal and transmitting the RF signal.

19. A receiver in a broadband wireless communication system, comprising:
a controller for receiving a resource allocation message including information about a data region adjusted according to a cell load, and generating a control signal to receive data in the adjusted data region;
a fast Fourier transform (FFT) processor for FFT-processing a received signal and outputting subcarrier values; and
a demapper for extracting subcarrier values with actual data among the subcarrier values received from the FFT processor.

20. The receiver of claim 19, wherein the resource allocation message is a hybrid automatic repeat request (HARQ) MAP message.

21. The receiver of claim 19, wherein the information about the adjusted data region comprises:
a symbol offset value indicating a start of the adjusted data region; and
a subchannel offset value indicating subchannels occupied by the adjusted data region.
